(19) United States
(12) Patent Application Publication
(10) Pub. No.: US 2019/0011763 A1
(43) Pub. Date: Jan. 10, 2019

(54) LIQUID CRYSTAL DISPLAY PANEL AND MANUFACTURING METHOD THEREOF

(71) Applicants: HKC Corporation Limited, Shenzhen (CN); Chongqing HKC Optoelectronics Technology Corporation Limited, Chongqing (CN)

(72) Inventor: YU-JEN CHEN, Chongqing (CN)

(21) Appl. No.: 15/744,827

(22) PCT Filed: Feb. 27, 2017
(86) PCT No.: PCT/CN2017/075012

§ 371 Date: Jan. 15, 2018

(30) Foreign Application Priority Data
Dec. 29, 2016 (CN) 2016112663211

(51) Int. Cl. G02F 1/1335; G02F 1/1339

(52) U.S. Cl. CPC G02F 1/133514; G02F 1/1339

(57) ABSTRACT

The present disclosure provides a liquid crystal display panel and a manufacturing method thereof. The manufacturing method includes providing a first substrate and a second substrate, forming an active switch array on the second substrate, successively forming a plurality of color filters on the second substrate to form the color filter layer, wherein portions of the color filters have different heights, forming a plurality of photo spacers on the color filter layer, and forming a liquid crystal layer between the first substrate and the second substrate.

### TECHNICAL FIELD

The present disclosure relates to the technical field of displays, and particularly relates to a liquid crystal display panel using a height difference of color filters to mismatch photo spacers (PS), and a manufacturing method thereof.

### BACKGROUND

In recent years, with the progress of science and technology, many different display apparatuses, such as liquid crystal display apparatuses (LCD apparatuses) or electro luminescence (EL) display apparatuses, are widely applied to flat panel displays. In taking the LCD apparatuses as an example, most LCD apparatuses are backlit LCD apparatuses, each including a liquid crystal display panel and a backlight module. Each liquid crystal display panel is composed of two transparent substrates and a liquid crystal enclosed between the substrates.

R/G/B color filters and photo spacers (PS) of the existing upper-panel color filter are manufactured at one side of an array substrate. The photo spacers (PS) are not easy to be mismatched, causing that dark fringes in images are easily formed during pressing. Therefore, cell quality is influenced and various traces are formed due to nonuniform brightness of the display apparatus.

### SUMMARY

A technical problem to be solved by the present disclosure is to provide a liquid crystal display panel, to avoid dark fringes in images. The liquid crystal display panel comprises:

a first substrate,

a second substrate comprising an active switch array and a color filter layer formed on the active switch array, where the color filter layer comprises a plurality Of color filters of different colors, and portions of the color filters have different heights,

a liquid crystal layer formed between the first substrate and the second substrate, and

a plurality of photo spacers positioned on the color filter layer.

In some embodiments, the color filters of a same color have different heights.

In some embodiments, the color filters of different color have different heights.

In some embodiments, the plurality of photo spacers have an identical length.

In some embodiments, the color filter comprises a first color filter and a second color filter. A height of the second color filter is greater than a height of the first color filter. The first color filter is provided with a color filter recess. Portion of the plurality of photo spacers are disposed on the color filter recess.

The present disclosure further provides a manufacturing method of the liquid crystal display panel. The manufacturing method comprises:

providing a first substrate and a second substrate,

forming an active switch array on the second substrate,

successively forming a plurality of color filters of different colors on the second substrate to form the color filter layer, wherein portions of the color filters are formed by using the gray mask or the half tone mask, to form the color filter with different heights,

forming a plurality of photo spacers on the color filter layer, and

forming a liquid crystal layer between the first substrate and the second substrate.

The present disclosure further provides a liquid crystal display panel comprising:

a first substrate,

a second substrate comprising an active switch array and a color filter layer formed on the active switch array wherein the color filter layer comprises a plurality of color filters of different colors, and portions of the color filters have different heights,

a liquid crystal layer formed between the first substrate and the second substrate, and

a plurality of photo spacers positioned on the color filter layer.

Wherein the color filters of a same color have different heights, the plurality of photo spacers have an identical length, a mismatch value exists among the plurality of photo spacers, and the mismatch value is greater than or equal to 0.5 μm.

Portions of the color filters are formed by using the gray mask or the half tone mask, to form the color filter with different heights.

Portions of the color filters have a first height and a second height, and a height difference between the first height and the second height is greater than or equal to 0.5 μm.

In some embodiments, the liquid crystal display apparatus comprises a backlight module and the liquid crystal display panel.

Mismatch may be formed between the two photo spacers by using color filters with different heights, to avoid influencing cell quality due to dark fringes in images caused during pressing, thereby enhancing display; realizing better display of the panel, enabling better viewing experiences for users, simultaneously saving cost and enhancing product competitiveness.

### DESCRIPTION OF THE DRAWINGS

The drawings included are used for providing further understanding of embodiments of the present application, constitute part of the description, are used for illustrating implementation manners of the present application, and interpreting principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a local sectional schematic diagram of a liquid crystal display panel of an embodiment of the present disclosure.

FIG. 2 is a structural schematic diagram of a liquid crystal display panel of an embodiment of the present disclosure.

FIG. 3 is a structural schematic diagram of a liquid crystal display panel of an embodiment of the present disclosure.

FIG. 4 is a structural schematic diagram of a liquid crystal display panel of an embodiment of the present disclosure.

FIG. 5 is a structural schematic diagram of a liquid crystal display panel fan embodiment of the present disclosure.

FIG. 6 is a structural schematic diagram of a liquid crystal display panel of an embodiment of the present disclosure.

FIG. 7 is a schematic diagram of a color filter of an embodiment of the present disclosure.

### DETAILED DESCRIPTION

Specific structure and function details disclosed herein are only representative and are used for the purpose of describing exemplary embodiments of the present disclosure. However, the present disclosure may be specifically achieved in many alternative forms and shall not be interpreted to be only limited to the embodiments described herein.

It should be understood in the description of the present disclosure that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present disclosure and the simplification of the description rather than to indicate or imply that the indicated apparatus or assembly must have a specific direction or constructed and operated in a specific direction, and therefore, shall not be understood as a limitation to the present disclosure. In addition, the terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present disclosure, the meaning of “a plurality of” is two or more unless otherwise specified. In addition, the term “comprise” and any variant are intended to cover non-exclusive inclusion.

It should be noted in the description of the present disclosure that, unless otherwise specifically regulated and defined, terms such as “installation”, “bonded” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two assemblies. For those of ordinary skill in the art, the meanings of the above terms in the present disclosure may be understood according to specific conditions.

The terms used herein are intended to merely describe specific embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

The present disclosure will be further described in detail below in combination with the drawings and preferred embodiments.

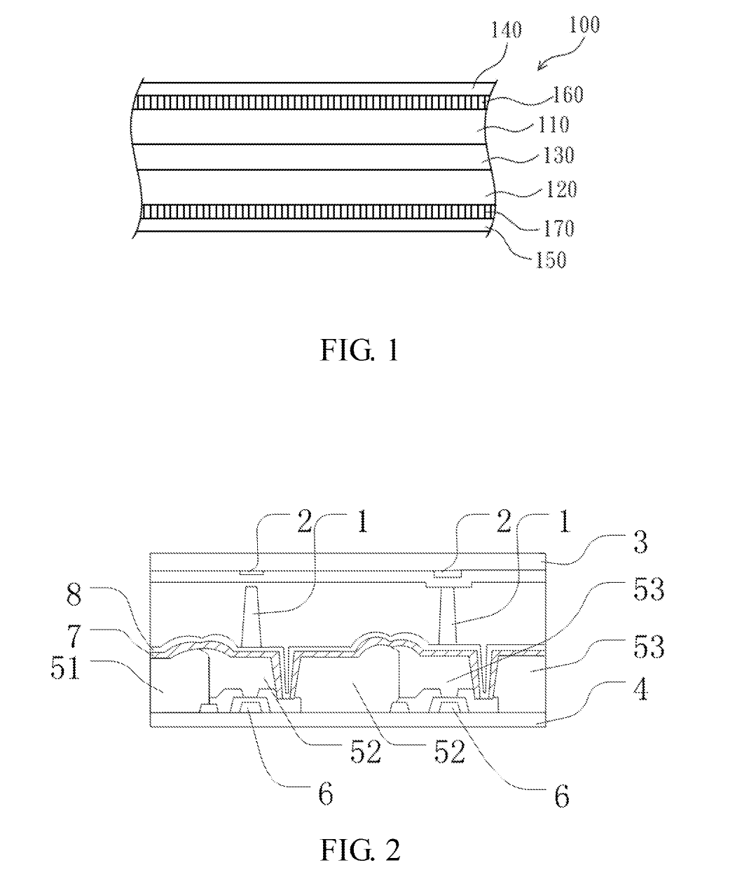

FIG. 1 is a local sectional schematic diagram of a liquid crystal display panel of an embodiment of the present disclosure. The liquid crystal display apparatus can comprise a liquid crystal display panel 100 and a backlight module (not shown). The liquid crystal display panel 100 is disposed relative to the backlight module. The backlight module may be a side lighting backlight module or a bottom lighting backlight module, to provide backlight to the liquid crystal display panel 100. The liquid crystal display panel 100 may be a VA liquid crystal display panel.

As shown in FIG. 1, the liquid crystal display panel 100 can comprise a first substrate 110, a second substrate 120, a liquid crystal layer 130, a first polarizer 140, a second polarizer 150 and phase difference films 160 and 170. The liquid crystal layer 130 is formed between the first substrate 110 and the second substrate 120, i.e., the liquid crystal layer 130 is positioned on the inner side of the first substrate 110 and the second substrate 120. The first polarizer 140 is disposed on the outer side of the first substrate 110. The second polarizer 150 is disposed on the outer side of the second substrate 120. The phase difference film 160 is disposed between the first substrate 110 and the first polarizer 140. The phase difference film 170 is disposed between the second substrate 120 and the second polarizer 150.

As shown in FIG. 1, the substrate materials of the first substrate 110 and the second substrate 120 may be glass substrates or flexible plastic substrates. It is worth noting that a color filter and an active switch array can be configured on the same substrate in the embodiment of the present disclosure.

The structural schematic diagram of the display panel of the embodiment of the present disclosure is described below with reference to FIG. 2 to FIG. 5. The display panel comprises a first substrate and a second substrate. A plurality of photo spacers 1 for supporting the first substrate and the second substrate are disposed between the first substrate and the second substrate. The photo spacers 1 are spacedly disposed, and comprise at least two photo spacers, i.e., a first photo spacer and a second photo spacers to be mismatched. Mismatch may be formed between the two photo spacers 1, to avoid influencing cell quality due to dark fringes in images caused during pressing, thereby enhancing a display effect, realizing better display taste of the panel, enabling a user to obtain better viewing experience, simultaneously save cost and enhance product competitiveness.

In another embodiment of the present disclosure, the display panel further comprises a black matrix 2. The black matrix 2 is disposed between the first substrate and the photo spacers 1. The black matrix 2 forms a height difference in positions corresponding to the two photo spacers 1. Accordingly, mismatch is formed between the two photo spacers 1. Multiple heights of the black matrix 2 are formed on the black matrix 2, to allow the corresponding photo spacers to form mismatch, thereby avoiding influencing cell quality due to dark fringes in images caused during pressing.

Specifically, FIG. 2 shows a structural schematic diagram of the display panel of an embodiment of the present disclosure. Through a half tone mask, the black matrix 2 forms the height difference in positions corresponding to two adjacent photo spacers 1. Accordingly, mismatch is formed between the two adjacent photo spacers 1. The two adjacent photo spacers 1 are mismatched, so that uniform arrangement of the mismatch is thoroughly used to increase liquid crystal margin, effectively avoid forming the dark fringes in the images and ensure the quality of the display panel. Of course, besides the mismatch formed between the two adjacent photo spacers 1, the mismatch can also exist between the photo spacers 1, and spaced distances may be uniform or may be in other specific sequences, wherein a difference value of the mismatch may be constant or variable.

The black matrix 2 forms the height difference in the positions corresponding to the two adjacent photo spacers 1 through the half tone mask. By using a gray mask or the half tone mask, working procedures accomplished by two exposure processes are merged into one working procedure, thereby saving one exposure process, shortening a production cycle, increasing production efficiency, reducing production cost and enhancing market competitiveness. Portion of light transmission of a grating is used in the gray mask or the half tone mask, so that a color filter is incompletely exposed. The light transmission quantity of light rays is determined by a semi-permeable membrane portion according to the height difference of a required passivation layer, and generally, the transmittance is about 35% of transmittance of a normal portion.

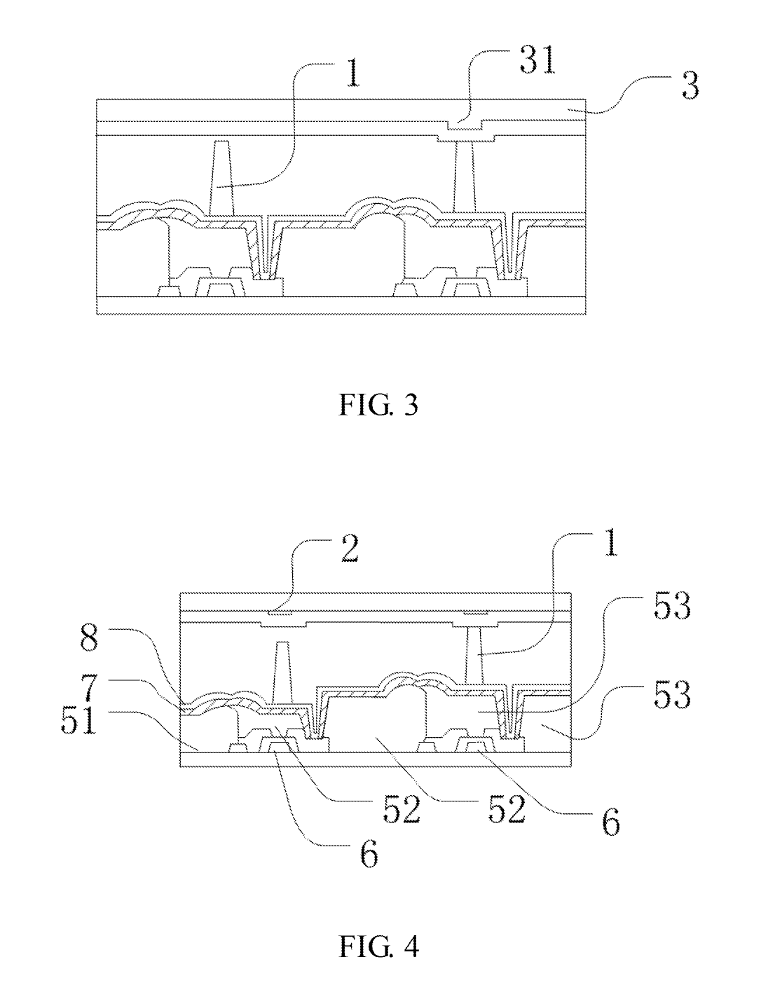

As shown in FIG. 3, in another embodiment of the present disclosure, the first substrate further comprises a first glass substrate 3, and the first glass substrate 3 is provided with protrusions 31 that protrude inwards in positions corresponding to the first photo spacer or the second photo space. A height difference is formed in positions corresponding to the two photo spacers by using the protrusions 31. Accordingly, the two photo spacers are mismatched. Structures of the protrusions 31 on the first glass substrate 3 are used and the protrusions 31 are disposed simply, to allow the corresponding photo spacers (PS) 1 to be mismatched, thereby avoiding influencing cell quality due to dark fringes in images caused during pressing. Of course, the first glass substrate 3 can be provided with protrusions 31 that protrude inwards in positions corresponding to the first photo spacer and the second photo space, but the protrusions 31 corresponding to the two photo spacers 1 have different heights.

Specifically, the protrusions 31 form the height difference in positions corresponding to the two adjacent photo spacers 1. Accordingly, mismatch is formed between the two adjacent photo spacers 1. The two adjacent photo spacers 1 are mismatched, so that uniform arrangement of the mismatch is thoroughly used to increase margin of a liquid crystal, effectively avoid forming dark fringes in images and ensure quality of the display panel. Of course, besides the mismatch formed between the two adjacent photo spacers 1, the mismatch can also exist between the photo spacers 1, and distances in space may be uniform or may be in other specific sequences, wherein a difference value of the mismatch may be constant or variable.

Specifically, FIG. 3 shows a structural schematic diagram of the display panel of an embodiment of the present disclosure. The height of one protrusion 31 in the two adjacent protrusions 31 is 0. In one of the positions corresponding to the two adjacent photo spacers 1 on the first glass substrate 3, no change is made. In an other position, the photo spacers 1 are made to mismatch by using the height of the protrusions 31.

More specifically, the second substrate of the liquid crystal display panel can comprise an active switch array and a color filter layer formed on the active switch array. The liquid crystal layer is formed between the first substrate and the second substrate. A plurality of photo spacers 1 are disposed between the first substrate and the second substrate, wherein a portion of the photo spacers 1 are positioned between the color filter layer and the protrusions 31 to support the first substrate and the second substrate. The other portion of the photo spacers 1 are positioned between the color filter layer and the protrusions 31, thereby mismatching the photo spacers 1.

In some embodiments, the plurality of photo spacers 1 may have an identical length, while the protrusions 31 are used to mismatch. Therefore, the photo spacers 1 can be formed without the use of a special mask (e.g., half tone mask), thereby reducing cost.

In some embodiments, length of the plurality of photo spacers is slightly less than a distance between the color filter layer and the protrusions. Therefore, a portion of the photo spacers 1 may be supported between the color filter layer and the protrusions.

In some embodiments, the first substrate comprises a glass substrate and the protrusions are integrally formed on the glass substrate.

In another embodiment of the present disclosure, the second substrate further comprises a second glass substrate 4 and a color filter layer. The color filter layer is disposed between the second glass substrate 4 and the photo spacers 1. The color filter layer forms a height difference in positions corresponding to the two photo spacers 1. Accordingly, mismatch is formed between the two photo spacers 1. Multiple heights of the color filter are formed on the color filter layer. The photo spacers (PS) 1 are manufactured on the color filter. After the photo spacers (PS) 1 are formed, the mismatch is formed by using the topographic advantage, thereby avoiding influencing cell quality due to dark fringes in images caused during pressing.

Specifically, the color filter layer forms the height difference in positions corresponding to the two adjacent photo spacers 1. Accordingly, mismatch is formed between the two adjacent photo spacers 1. The two adjacent photo spacers 1 are mismatched, so that uniform arrangement of the mismatch is thoroughly used to increase a liquid crystal margin, effectively avoid forming the dark fringes in the images and ensure the quality of the display panel. Of course, besides the mismatch formed between the two adjacent photo spacers 1, the mismatch may also exist between the photo spacers 1, and distances in space be uniform or may be in other specific sequences, wherein a difference value of the mismatch may be constant or variable.

Specifically, FIG. 4 shows a structural schematic diagram of the display panel of an embodiment of the present disclosure. The color filter layer comprises an R color filter 51, G color filters 52 and a B color filter. Two adjacent G color filters 52 form the height difference through the half tone mask. Accordingly, the photo spacers 1 disposed on the G color filters 52 and the B color filter 53 are mismatched, to effectively solve the problem of the dark fringes in the images.

Specifically, the color filter layer forms the height difference in positions corresponding to the two adjacent photo spacers 1 through the half tone mask. By adopting a gray mask or the half tone mask, working procedures accomplished by two exposure processes are merged into one working procedure, thereby saving one exposure process, shortening a production cycle, increasing production efficiency, reducing production cost and enhancing market competitiveness. Portion of light transmission of a grating is used in the half tone mask, so that a color filter is exposed incompletely. The light transmission quantity of light rays is determined by a semi-permeable membrane portion according to the height difference of a required passivation layer, and generally, the transmittance is about 35% of transmittance of a normal portion.

More specifically, a second substrate may comprise an active switch array and a color filter layer formed on the active switch array. The color filter layer comprises a plurality of color filters of different colors 51, 52 and 53 and portions of the color filters have different heights. For example, the color filter 52 in FIG. 4 can have different heights, wherein portions of the color filters are formed by using the gray mask or the half tone mask, to form the color filter with different heights.

More specifically, the manufacturing method of the liquid crystal display panel comprises:

providing a first substrate and a second substrate;

forming an active switch array on the second substrate;

successively forming a plurality of color filters of different colors on the second substrate to form the color filter layer, wherein portions of the color filters are formed by using the gray mask or the half tone mask, to form the color filter with different heights;

forming a plurality of photo spacers on the color filter layer; and

forming a liquid crystal layer between the first substrate and the second substrate.

In some embodiments, the color filter of a same color has different heights. For example, the color filter 52 may have a first height and a second height, the first height is different from the second height, and a height difference between the first height and the second height is greater than or equal to 0.5 μm.

In some embodiments, the color filters of different colors have different heights. For example, the color filter 51 has a first height, the color filter 52 has a second height, the first height is different from the second height, and a height difference between the first height and the second height is greater than or equal to 0.5 μm.

In some embodiments, the plurality of photo spacers 1 may have an identical length, while the color filters 51, 52 and 53 with different heights are used to mismatch. Therefore, the photo spacers 1 can be formed without the use of a special mask (e.g. half tone mask), thereby reducing cost.

In another embodiment of the present disclosure, the second substrate further comprises a second glass substrate 4 and a color filter layer. The color filter layer is disposed between the second glass substrate 4 and the photo spacers 1. A protective layer 7 is disposed between the color filter layer and the photo spacers 1. The protective layer 7 forms a height difference in positions corresponding to the two photo spacers 1. Accordingly, mismatch is formed between the two photo spacers 1. The protective layer 7 under the photo spacers (PS) 1 has different heights. The photo spacers (PS) 1 are manufactured on the protective layer 7. After the photo spacers (PS) 1 are formed, the mismatch is formed by using the topographic advantage, thereby avoiding influencing cell quality due to dark fringes in images caused during pressing.

Specifically, the protective layer 7 forms the height difference in positions corresponding to the two adjacent photo spacers 1. Accordingly, mismatch is formed between the two adjacent photo spacers 1. The two adjacent photo spacers 1 are mismatched, so that uniform arrangement of the mismatch is used to increase margins of a liquid crystal, effectively avoid forming dark fringes in images and ensure quality of the display panel. Of course, besides the mismatch formed between the two adjacent photo spacers 1, mismatch can also exist between the photo spacers 1, and distances in space may be uniform or in other specific sequences, wherein a difference value of the mismatch may be constant or variable.

Specifically, the color filter layers in positions corresponding to the photo spacers 1 have the same height. A conducting layer is disposed between the first photo spacer and the corresponding color filter layer. The conducting layer and the protective layer are disposed between the second photo spacer and the corresponding color filter layer. The protective layer 7 under the corresponding photo spacer (PS) 1 is directly removed to mismatch, which is simple in step, wherein thin film transistors 6 are also disposed on the second substrate, and the first photo spacer and the second photo spacer are respectively disposed above the two adjacent thin film transistors 6. The thin film transistors 6 are compositions formed by stacking a plurality of polygons as shown in the figure, and the conducting layer 8 is bonded with drains in the thin film transistors 6, wherein the color filter layers corresponding to the two photo spacers 1 have different colors.

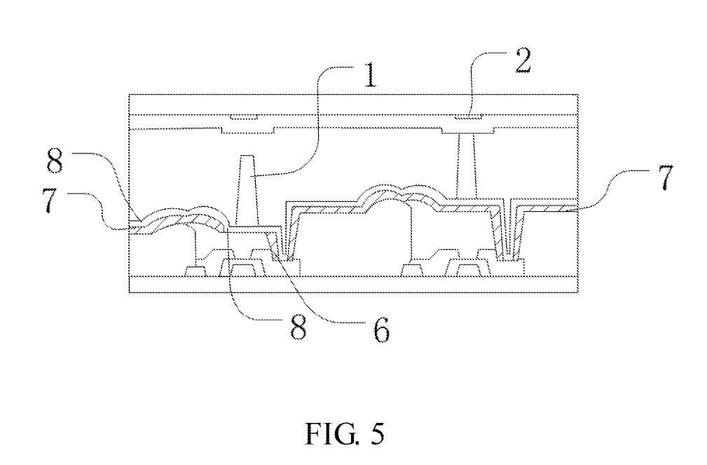

Specifically, besides the protective layer 7 in a corresponding position can only be removed to mismatch between the photo spacers 1, the mismatch can also be formed more adequately in such a manner that the color filter is processed through the half tone mask to form the height difference. FIG. 5 shows a structural schematic diagram of the display panel of an embodiment of the present disclosure. The color filter layer comprises an R color filter 51, G color filters 52 and a B color filter. Two adjacent G color filters 52 form the height difference through the half tone mask. Meanwhile, the protective layer 7 under one G color filter 52 is removed. Accordingly, the photo spacers 1 disposed on the G color filters 52 and the B color filter 53 are mismatched, to effectively solve the problem of the dark fringes in the images.

In another embodiment of the present disclosure, contact surfaces of the first photo spacer and the second photo spacer with the first substrate have differences in height. Contact surfaces of the first photo spacer and the second photo spacer with the second substrate have differences in height. Accordingly, the two photo spacers 1 are mismatched. The mismatch is formed in both of two substrate directions, and the mismatch can be increased for the convenience of successfully making the entire display panel, thereby avoiding influencing a display effect of the display panel due to a limited mismatch value.

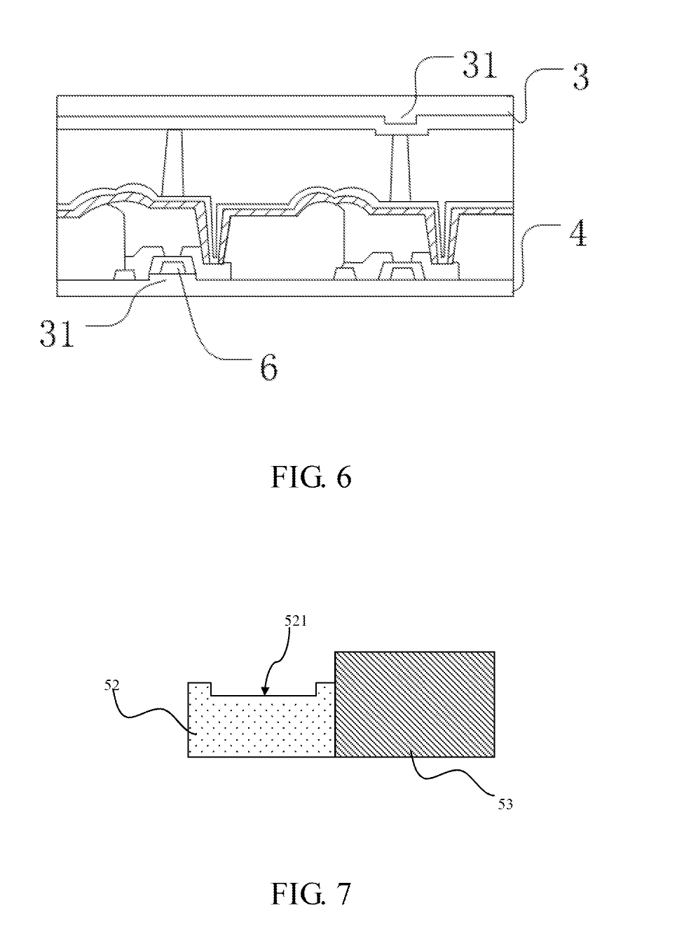

Specifically, FIG. 6 shows a structural schematic diagram of the display panel of an embodiment of the present disclosure. The first glass substrate 3 forms the protrusion 31 in a position of one corresponding photo spacer 1, and the second glass substrate 4 forms the protrusion 31 in a position of one corresponding photo spacer 1, so that the two photo spacers 1 are mismatched with a greater difference value. Of course, besides the manner that the glass substrate is provided with the protrusions 31 that protrude inwards, other manners can also be adopted. The manners adopted at one side of the first substrate and at one side of the second substrate may be also different.

A photo-initiator in each photo spacer 1 is identical. The same photo-initiator is disposed in different photo spacers 1. Irradiated by light rays of different wavelengths, the different photo spacers 1 produce cross-linking reactions of different degrees, thereby achieving that different photo spacers 1 are mismatched. The light rays of different wavelengths are adopted for irradiating the same photo-initiator and the photo spacers 1. The different photo spacers 1 are controlled to produce the cross-linking reactions of different degrees under the effect of the light rays of different wavelengths, to further control the shrinkage of the different photo spacers 1. A control effect is good, so that the mismatch between the different photo spacers 1 achieves a preset need. In addition, for such configuration on a production process, the different photo spacers 1 are not required to be configured differently, and the configuration is simple.

FIG. 7 shows a schematic diagram of the color filter of an embodiment of the present disclosure. In some embodiments, the color filter comprises a first color filter 52 and a second color filter 53. A height of the second color filter 52 is greater than a height of the first color filter 53. The first color filter 52 is provided with a color filter recess 521. A portion of the plurality of photo spacers 1 are disposed on the color filter recess 521, to be mismatched with a greater difference value between the photo spacers 1.

Specifically, the black matrix 2 and the second photo spacer are configured to have the same height, the first photo spacer is higher than the second photo space, and the second photo spacer is positioned between the first photo spacer and the black matrix 2. It is better for the first photo spacer to be configured to be higher than the second photo spacer and the black matrix 2, the second photo spacer is configured to have an equal height to the black matrix 2, and the heights of the first photo space, the second photo spacer and the black matrix 2 are controlled, the control effect for the mismatch is better, so that the display effect of the display panel is better.

The mismatch value between the first photo spacer and the second photo spacer is greater than or equal to 0.5 μm. Specifically, the height difference between the height H1 of the first photo spacer and the height H2 of the second photo spacer is greater than or equal to 0.5 μm. When the mismatch value between the first photo. spacer and the second photo spacer is less than 0.5 μm, a display influence on the display panel is large and other manufacturing processes are influenced, so the difficulty of the entire display panel is increased. The shrinkage among the different photo spacers is controlled under the coordination effect of the light rays of different wavelengths and the photo-initiator, to control the mismatch between the first photo spacer and the second photo spacer to be greater than or equal to 0.5 μm, thereby facilitating the successful manufacturing of the entire display panel and avoiding influencing the display effect of the display panel due to a limited mismatch value.

According to another aspect of the present disclosure, the present disclosure further discloses a display apparatus comprising the backlight module and the above display panel.

As still another embodiment of the present disclosure, the present embodiment discloses the backlight module and the display panel of the display apparatus. See FIG. 1 to FIG. 4 for specific structures and bonding relationships of the display panel, which will not be described in detail herein.

The above contents are further detailed descriptions of the present disclosure in combination with specific preferred embodiments. However, the specific implementation of the present disclosure shall not be considered to be only limited to these descriptions. For those of ordinary skill in the art to which the present disclosure belongs, several simple deductions or replacements may be made without departing from the conception of the present disclosure, all of which shall be considered to belong to the protection scope of the present disclosure.

1. A liquid crystal display panel, comprising:
a first substrate;
a second substrate comprising an active switch array and a color filter layer formed on the active switch array, wherein the color filter layer comprises a plurality of color filters of different colors, and portions of the color filters have different heights;
a liquid crystal layer formed between the first substrate and the second substrate; and
a plurality of photo spacers positioned on the color filter laver.

2. The liquid crystal display panel according to claim 1, wherein the color filters of a same color have different heights.

3. The liquid crystal display panel according to claim 1, wherein the color filters of different colors have different heights.

4. The liquid crystal display panel according to claim 1, wherein the plurality of photo spacers have an identical length.

5. The liquid crystal display panel according to claim 1, wherein the color filter comprises a first color filter and a second color filter;
wherein a height of the second color filter is greater than a height of the first color filter;
wherein the first color filter is provided with a color filter recess; and
a portion of the plurality of photo spacers are disposed on the color filter recess.

6. A manufacturing method of a liquid crystal display panel, comprising:
providing a first substrate and a second substrate;
forming an active switch array on the second substrate;
successively forming a plurality of color filters of different colors on the second substrate to form the color filter layer, wherein portions of the color filters are formed by using the gray mask or the half tone mask, to form the color filter with different heights;
forming a plurality of photo spacers on the color filter layer; and
forming a liquid crystal layer between the first substrate and the second substrate.

7. The manufacturing method of the liquid crystal display panel according to claim 6, wherein the color filters of a same color have different heights.

8. The manufacturing method of the liquid crystal display panel according to claim 6, wherein the color filters of different colors have different heights.

9. The manufacturing method of the liquid crystal display panel according to claim 6, wherein the plurality of photo spacers have an identical length.

10. The manufacturing method of the liquid crystal display panel according to claim 6, wherein the color filter comprises a first color filter and a second color filter;
wherein a height of the second color filter is greater than a height of the first color filter;
wherein the first color filter is provided with a color filter recess; and
a portion of the plurality of photo spacers are disposed on the color filter recess.

11. A liquid crystal display panel, comprising:
a first substrate;
a second substrate comprising an active switch array and a color filter layer formed on the active switch array, wherein the color filter layer comprises a plurality of color filters of different colors, and portions of the color filters have different heights;
a liquid crystal layer formed between the first substrate and the second substrate; and
a plurality of photo spacers positioned on the color filter layer.
wherein the plurality of photo spacers have an identical length, a mismatch value exists among the plurality of photo spacers, and the mismatch value is greater than or equal to 0.5 μm.
wherein portions of the color filters are formed by using the gray mask or the half tone mask, to form the color filter with different heights.
wherein portions of the color filters have a first height and a second height, and a height difference between the first height and the second height is greater than or equal to 0.5 μm.
wherein the color filter comprises a first color filter and a second color filter; a height of the second color filter is greater than a height of the first color filter; the first color filter is provided with a color filter recess; and a portion of the plurality of photo spacers are disposed on the color filter recess.
